(19) United States
(12) Patent Application Publication
(10) Pub. No.: US 2009/0242508 A1
(43) Pub. Date: Oct. 1, 2009

(54) Method for manufacturing magnetic recording medium

(75) Inventors: Kazuhiro Hattori, Tokyo (JP); Shuichi Okawa, Tokyo (JP); Narutoshi Fukuzawa, Tokyo (JP); Takahiro Suwa, Tokyo (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/382,653

(22) Filed: Mar. 20, 2009

(30) Foreign Application Priority Data
Mar. 25, 2008 (JP) 2008-076924

(51) Int. Cl. B44C 1/22

(52) U.S. Cl. 216/22

(57) ABSTRACT

A filling material different from a first mask layer (temporary coating material) is deposited over a workpiece to fill concave portions. At least part of excess portions of the filling material is removed by a dry etching method such that at least part of the side surfaces of the first mask layer over recording elements are exposed. Then, the first mask layer is removed by a dry etching method which uses a reactive gas having the property of chemically reacting with and removing both the filling material and the first mask layer as a processing gas and in which an etching rate for the first mask layer is higher than that for the filling material, and the etching rate for the filling material is higher than that for a recording layer (a lower layer that is in contact with a lower surface of the first mask layer over recording elements).

### BACKGROUND OF THE INVENTION

1. Field of the Invention

The present invention relates to a method for manufacturing a magnetic recording medium including a recording layer formed in a concavo-convex pattern.

2. Description of the Related Art

Conventionally, a significant improvement in the areal density of magnetic recording media such as hard disks has been achieved by, for example, reducing the size of magnetic particles constituting the recording layer, changing materials, and improving the precision of head processing. A further improvement in the areal density is expected in the future. However, problems caused by the limit of magnetic head processing and by the broadening of the recording magnetic field of the magnetic head have become apparent, such as incorrect recording of information on a track adjacent to a target recording track and crosstalk during reproduction. The improvement of the areal density by conventional improvement techniques has reached the limit.

In view of this, discrete track media and patterned media have been proposed as candidates for magnetic recording media in which a further improvement in the areal density can be achieved. Such discrete track media and patterned media include a recording layer formed in a concavo-convex pattern, wherein the convex portions of the concavo-convex pattern serve as recording elements (see, for example, Japanese Patent Application Laid-Open No. Hei 09-97419). Meanwhile, in magnetic recording media such as hard disks, the flatness of their surfaces is an important factor to stabilize the head flying height so that good recording-reproducing characteristics are achieved. Therefore, preferably, a filling material is deposited over the recording layer formed in a concavo-convex pattern to fill the concave portions between the recording elements, so that the upper surfaces of the recording elements and the filling material are flattened. A non-magnetic oxide or nitride having high hardness may be used as the filling material. A sputtering method, for example, may be used as the method to deposit the filling material and fill the concave portions. The filling material is deposited in a concavo-convex pattern following the concavo-convex pattern of the recording layer and is also formed over the recording elements. Dry etching may be used as a technique for removing the excess portion of the filling material and flattening the surface.

With dry etching, convex portions tend to be selectively removed at a faster rate than concave portions. Therefore, dry etching is suitable for flattening. However, with dry etching, the concave portions of the filling material, in addition to the convex portions, are also removed to some extent. Moreover, the etching rate is higher for narrow convex portions than for wide convex portions. Therefore, even when the excess portions of the filling material formed in a concavo-convex pattern are removed by dry etching, the surface may not be sufficiently flattened.

In view of the above, an improved method has been proposed (see, for example, Japanese Patent Application Laid-Open No. 2006-196143). In this method, a workpiece having a temporary coating material formed over the recording elements is prepared, and a filling material is deposited over the workpiece to fill the concave portions. Then, at least part of the excess portions of the filler material is removed by dry etching. Next, the temporary coating material is selectively removed using an etching method in which an etching rate for the temporary coating material is higher than an etching rate for the filling material in order to flatten the surface.

In this method, the temporary coating material is selectively removed using the etching method in which the etching rate for the temporary coating material is higher than the etching rate for the filling material. Therefore, it was expected that all the convex portions formed of the temporary coating material would be removed in a short period of time irrespective of their width with the processing of the filling material in the concave portions suppressed, so that the surface of the workpiece could be easily flattened.

However, in practice, even when the above method is used, the surface of the workpiece is not sufficiently flattened in some cases.

### SUMMARY OF THE INVENTION

In view of the foregoing problems, various exemplary embodiments of this invention provide a method for manufacturing a magnetic recording medium including a recording layer formed in a concavo-convex pattern and having a sufficiently flat surface.

According to various exemplary embodiments of the present invention, the above object is achieved by the following. First, a workpiece is produced, which includes: a substrate; a recording layer formed in a predetermined concavo-convex pattern over the substrate, the concavo-convex pattern including convex portions that serve as recording elements; and a temporary coating material formed over at least the recording elements of the recording layer. A filling material different from the temporary coating material is deposited over the workpiece to fill concave portions of the concavo-convex pattern. At least part of excess portions of the filling material are removed by a dry etching method such that at least part of the side faces of the temporary coating material formed over the recording elements are exposed. Here, the excess portions of the filling material are portions formed on an upper side of a level of a lower surface of the temporary coating material over the recording elements, the upper side being the side opposite to the substrate. The temporary coating material is removed by a dry etching method which uses, as a processing gas, a reactive gas having the property of chemically reacting with and removing both the filling material and the temporary coating material. In this dry etching method, an etching rate for the temporary coating material is higher than an etching rate for the filling material, and the etching rate for the filling material is higher than an etching rate for a lower layer that is in contact with the lower surface of the temporary coating material over the recording elements.

In the course of completing the present invention, the present inventors have conducted extensive studies to determine why the surface of a workpiece cannot be sufficiently flattened in some cases even with the aid of the conventional method using a temporary coating material. As a result of the studies, the inventors have found that, even when a processing gas expected to selectively remove the temporary coating material at a fast rate is used, the temporary coating material may not be sufficiently removed in practice in the step of removing the temporary coating material.

The cause of the above is not clear. However, it can be presumed that a component of the filling material may migrate into the upper surface portion of the temporary coating material since the filling material is in contact with the upper surface of the temporary coating material. In such a case, the etching rate for the upper surface portion of the temporary coating material may be lower than the etching rate for the pure temporary coating material.

In view of the above problem, a reactive gas having the property of chemically reacting with and removing not only the temporary coating material but also the filling material is used as the processing gas. In this manner, the temporary coating material can be reliably removed even when a component of the filling material is introduced into the upper surface portion of the temporary coating material. The filling material filled in the concave portions also chemically reacts with the reactive gas. However, since the etching rate for the filling material is lower than the etching rate for the temporary coating material, the removed amount of the filling material is less than the removed amount of the temporary coating material. Accordingly, the surface of the workpiece is flattened.

Accordingly, various exemplary embodiments of this invention provide a method for manufacturing a magnetic recording medium, comprising: a workpiece producing step of producing a workpiece including a substrate, a recording layer formed over the substrate in a predetermined concavo-convex pattern that includes convex portions serving as recording elements, and a temporary coating material formed over at least the recording elements of the recording layer; a filling material depositing step of depositing, over the workpiece, a filling material different from the temporary coating material to fill concave portions of the concavo-convex pattern; a filling material etching step of removing at least part of an excess portion of the filling material by a dry etching method such that at least part of a side face of the temporary coating material formed over the recording elements is exposed, the excess portion of the filling material being a portion formed on an upper side of a level of a lower surface of the temporary coating material over the recording elements, the upper side being a side opposite to the substrate; and a temporary coating material removing step of removing the temporary coating material by a dry etching method which uses, as a processing gas, a reactive gas having a property of chemically reacting with and removing both the filling material and the temporary coating material and in which an etching rate for the temporary coating material is higher than an etching rate for the filling material and the etching rate for the filling material is higher than an etching rate for a lower layer that is in contact with the lower surface of the temporary coating material over the recording elements.

In the description of the present application, the phrase “a recording layer formed in a concavo-convex pattern including convex portions that serve as recording elements” is used to refer to a recording layer formed in a predetermined pattern by dividing a continuous recording layer such that the convex portions of the pattern serving as the recording elements are completely separated from each other. In addition, the above phrase is also used to include: a recording layer including convex portions that are separated from each other in data areas but are continuous near the boundaries between the data areas and servo areas; a recording layer formed continuously over a part of a substrate (like, for example, a recording layer having a spiral shape); a recording layer formed separately on the upper surfaces of the convex portions of a concavo-convex pattern of a layer below the recording layer and on the bottom surfaces of the concave portions of the concavo-convex pattern, wherein the portions formed on the upper surfaces of the convex portions serve as the recording elements; a recording layer including concave portions that are formed to a certain depth in the thickness direction such that the recording layer is continuous in the bottom portion; and a recording layer formed of a continuous film deposited in a concavo-convex pattern following the concavo-convex pattern of a layer below the recording layer.

In the description of the present application, when the recording layer is in contact with the lower surface of the temporary coating material, “the lower layer that is in contact with the lower surface of the temporary coating material over the recording elements” is the recording layer. When a barrier film, for example, is interposed between the temporary coating material and the recording elements and the lower surface of the temporary coating material is in contact with the barrier film, “the lower layer” is the barrier film.

In the description of the present application, the term “the material containing carbon as a main component” is used to refer to a material in which the ratio of the number of C (carbon) atoms to the total number of atoms constituting the material is 70% or more.

In the description of the present application, the term “the upper surface of the filling material” is used to refer to the surface of the filling material that is the surface opposite to the substrate.

In addition, in the description of the present application, the term “magnetic recording medium” is not limited to media, such as hard disks, FLOPPY (Registered Trade Mark) disks, and magnetic tapes, in which magnetism alone is used to record and reproduce information. The term is also used to refer to magneto-optical recording media, such as MO (magneto-optical) disks, in which both magnetism and light are used and to heat assisted type recording media in which both magnetism and heat are used.

### BRIEF DESCRIPTION OF THE DRAWINGS

FIG. 1 is a schematic cross-sectional side view illustrating the structure of a magnetic recording medium according to a first exemplary embodiment of the present invention;

FIG. 2 is an enlarged cross-sectional side view illustrating the structure around the filling material of the magnetic recording medium;

FIG. 3 is a schematic cross-sectional side view illustrating the structure of a starting body of a workpiece used in the manufacturing process of the magnetic recording medium;

FIG. 4 is a flowchart showing the outline of the manufacturing process;

FIG. 5 is a schematic cross-sectional side view illustrating the shape of the workpiece having thereon a resin layer formed in a concavo-convex pattern;

FIG. 6 is a schematic cross-sectional side view illustrating the shape of the workpiece with a recording layer processed into a concavo-convex pattern;

FIG. 7 is a schematic cross-sectional side view illustrating the shape of the workpiece with a filling material deposited over the recording layer;

FIG. 8 is a schematic cross-sectional side view illustrating the shape of the workpiece with the filling material etched;

FIG. 9 is a schematic cross-sectional side view illustrating the shape of the workpiece flattened by removing a first mask layer (temporary coating material);

FIG. 10 is a schematic cross-sectional side view illustrating another example of the shape of the workpiece flattened by removing the first mask layer (temporary coating material);

FIG. 11 is a schematic cross-sectional side view illustrating the structure of a starting body of a workpiece used in the manufacturing process of a magnetic recording medium according to a second exemplary embodiment of the present invention;

FIG. 12 is a schematic cross-sectional side view illustrating the shape of the workpiece having thereon a resin layer formed in a concavo-convex pattern;

FIG. 13 is a schematic cross-sectional side view illustrating the shape of the workpiece with a recording layer and a barrier film processed into a concavo-convex pattern;

FIG. 14 is a schematic cross-sectional side view illustrating the shape of the workpiece with a filling material deposited over the recording layer and the barrier film;

FIG. 15 is a schematic cross-sectional side view illustrating the shape of the workpiece with the filling material etched;

FIG. 16 is a schematic cross-sectional side view illustrating the shape of the workpiece flattened by removing a first mask layer (temporary coating material);

FIG. 17 is a schematic cross-sectional side view illustrating another example of the shape of the workpiece flattened by removing the first mask layer (temporary coating material);

FIG. 18 is a schematic cross-sectional side view illustrating the shape of a workpiece used in the manufacturing process of a magnetic recording medium according to a third exemplary embodiment of the present invention, the workpiece having a temporary coating material deposited over a recording layer formed in a concavo-convex pattern;

FIG. 19 is a flowchart showing the outline of the manufacturing process of a magnetic recording medium according to a fourth exemplary embodiment of the present invention; and

FIG. 20 is a schematic cross-sectional side view illustrating the shape of a workpiece after completion of an upper surface portion removing step in a fifth exemplary embodiment of the present invention.

### DETAILED DESCRIPTION OF THE PREFERRED EMBODIMENTS

Hereinafter, preferred exemplary embodiments of the present invention will be described in detail with reference to the drawings.

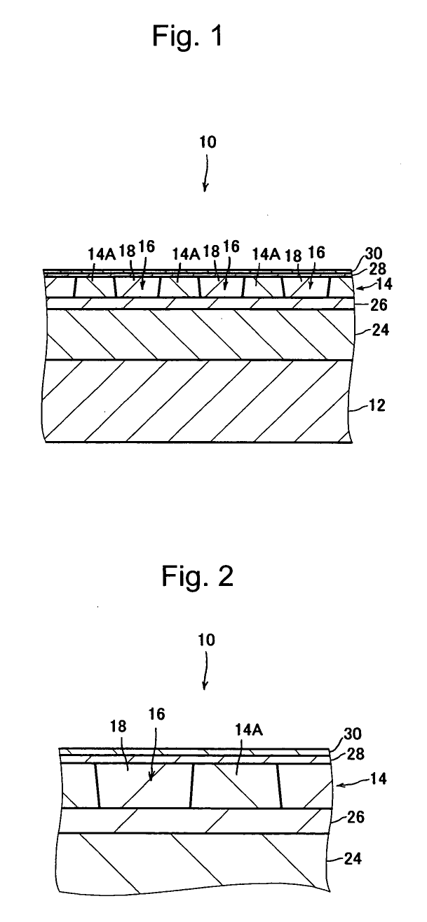

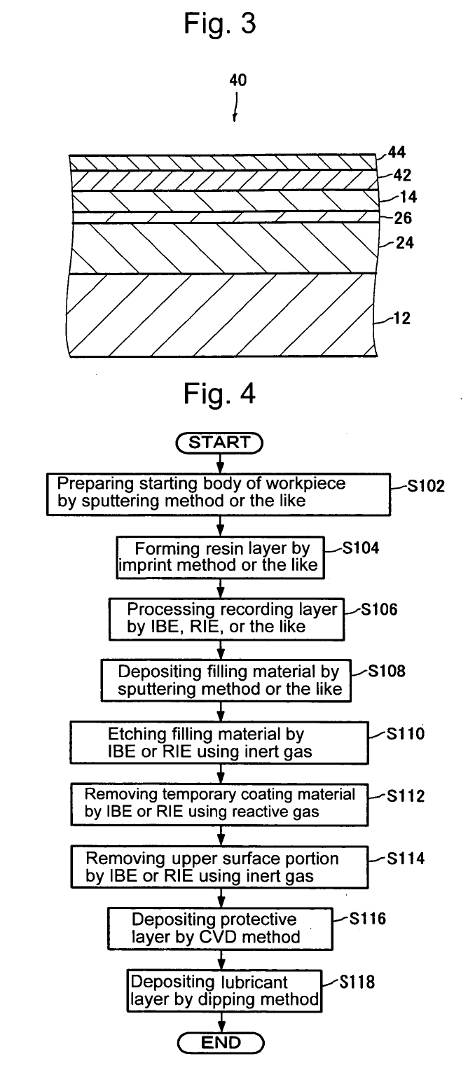

A first exemplary embodiment of the present invention relates to a method for manufacturing a discrete track magnetic recording medium 10 of the perpendicular recording type that includes a recording layer 14 formed in a predetermined concavo-convex pattern including convex portions serving as recording elements 14A, as shown in FIGS. 1 and 2. More specifically, in the first exemplary embodiment, a starting body of a workpiece 40 shown in FIG. 3 is processed such that a recording layer 14 (being a continuous film before being processed into a concavo-convex pattern) is divided into a large number of recording elements 14A shown in FIGS. 1 and 2 to form the recording layer 14 in a concavo-convex pattern. Subsequently, concave portions 16 between the recording elements 14A are filled with a filling material 18. Further, excess portions of the filling material 18 are removed to flatten the surface. The first exemplary embodiment is characterized by these steps. The description of the other steps will be omitted as appropriate because it does not seem to be important for an understanding of the first exemplary embodiment.

First, to understand the first exemplary embodiment, the configuration of the magnetic recording medium 10 will be briefly described.

The magnetic recording medium 10 includes a substrate 12, a soft magnetic layer 24, a seed layer 26, the recording layer 14, a protective layer 28, and a lubricant layer 30, and these layers are formed over the substrate 12 in that order. The magnetic recording medium 10 further includes the filling material 18 filled in the concave portions 16 between the recording elements 14A.

The substrate 12 has a substantially disk-like shape with a center hole. Glass, Al, Al₂O₃, or the like may be used as the material for the substrate 12.

The recording layer 14 has a thickness of 5 to 30 nm. A CoPt-based alloy such as a CoCrPt alloy, an FePt-based alloy, a stacked layer thereof, a material formed of a matrix of an oxide material, such as SiO₂, and ferromagnetic particles arrayed in the matrix, such as CoCrPt particles, or the like may be used as the material for the recording layer 14. In a data area, the recording elements 14A, which are convex portions of the recording layer 14, are formed in concentric arc shapes radially separated at microscopic intervals, as shown in FIGS. 1 and 2. In the data area, the radial width of the upper surfaces of the recording elements 14A is 10 to 100 nm. The radial width of the concave portions 16 at the level of the upper surfaces of the recording elements 14A is 10 to 100 nm. In a servo area, the recording elements 14A are formed in a predetermined servo pattern (not shown).

Preferably, the filling material 18 is a material containing any of Ge, Sb, Si, Ta, Ti, and W. More specifically, suppose the case where a reactive gas containing nitrogen, such as N₂ gas or NH₃ gas, is used as a processing gas in a temporary coating material removing step (S112) described later. In this case, the filling material 18 is preferably any one of Ge, Ge nitrides, Ge oxides, mixtures containing Ge, Ge alloys, compounds of Ge, Sb, Sb nitrides, Sb oxides, mixtures containing Sb, Sb alloys, and compounds of Sb. Also in this case, the filling material 18 is more preferably a material containing at least one of Ge and Sb as a main component. The “material containing at least one of Ge and Sb as a main component” means that the material contains one or both of Ge and Sb and that the ratio of the number of Ge or Sb atoms or the total number of Ge and Sb atoms to the total number of metal and/or semimetal atoms, except oxygen and nitrogen atoms, constituting the filling material is equal to or greater than the ratio of the number of atoms of each of metal and semimetal atoms except Ge and Sb. Preferably, in the above case, the filling material 18 contains one or both of Ge and Sb, and the ratio of the number of Ge or Sb atoms or the total number of Ge and Sb atoms to the total number of metal and/or semimetal atoms, except oxygen and nitrogen atoms, constituting the filling material is 50% or more.

Alternatively suppose the case where a reactive gas containing fluorine, such as CF₄ gas, C₂F₆ gas, C₄F₈ gas, SF₆ gas, or CHF₃ gas, is used as the processing gas in the temporary coating material removing step (S112) described later. In this case, the filling material 18 is preferably any one of Ge, Ge nitrides, Ge oxides, mixtures containing Ge, Ge alloys, compounds of Ge, Si, Si nitrides, Si oxides, mixtures containing Si, Si alloys, compounds of Si, Ta, Ta nitrides, Ta oxides, Ta alloys, Ti, Ti nitrides, Ti oxides, Ti alloys, W, W nitrides, W oxides, and W alloys. Also in this case, the filling material 18 is more preferably a material containing at least one of Ge, Si, Ta, Ti, and W as a main component. The “material containing at least one of Ge, Si, Ta, Ti, and W as a main component” means that the material contains one or a plurality of elements selected from Ge, Si, Ta, Ti, and W and that the ratio of the number of atoms of the one or the plurality of elements selected from Ge, Si, Ta, Ti, and W to the total number of metal and/or semimetal atoms, except oxygen and nitrogen atoms, constituting the filling material is equal to or greater than the ratio of the number of atoms of each of metal and semimetal atoms except Ge, Si, Ta, Ti, and W. Preferably, in the above case, the filling material 18 contains one or a plurality of elements selected from Ge, Si, Ta, Ti, and W, and the ratio of the number of atoms of the one or the plurality of elements selected from Ge, Si, Ta, Ti, and W to the total number of metal and/or semimetal atoms, except oxygen and nitrogen atoms, constituting the filling material is 50% or more.

The soft magnetic layer 24 has a thickness of 50 to 300 nm. An Fe alloy, a Co alloy, or the like may be used as the material for the soft magnetic layer 24.

The seed layer 26 has a thickness of 2 to 40 nm. A nonmagnetic CoCr alloy, Ti, Ru, a stacked layer of Ru and Ta, MgO, or the like may be used as the material for the seed layer 26.

The protective layer 28 has a thickness of 1 to 5 nm. DLC (diamond-like carbon) may be used as the material for the protective layer 28.

The lubricant layer 30 has a thickness of 1 to 2 nm. PFPE (perfluoropolyether) may be used as the material for the lubricant layer 30.

A description will now be+given of a method for manufacturing the magnetic recording medium 10 with reference to the flowchart shown in FIG. 4.

First, a starting body of a workpiece 40 shown in FIG. 3 is prepared (S102). The starting body of the workpiece 40 can be obtained by depositing the soft magnetic layer 24, the seed layer 26, the recording layer 14 (being a continuous film before being processed into a concavo-convex pattern), a first mask layer 42, and a second mask layer 44 in that order on the substrate 12 using a sputtering method or the like.

The first mask layer 42 has a thickness of 3 to 50 nm. The first mask layer 42 also serves as a temporary coating material that is to be removed in a short period of time using a nitrogen-containing reactive gas (such as N₂ or NH₃ gas) or a fluorine-containing reactive gas (such as CF₄, C₂F₆, C₄F₈, SF₆, or CHF₃ gas) used in the temporary coating material removing step (S112) described later. A material containing C (carbon) as a main component (such as DLC) or a resin may be used as the material for the first mask layer 42. The second mask layer 44 has a thickness of 3 to 30 nm. Ni, Al, Ge, SbGe, or the like may be used as the material for the second mask layer 44.

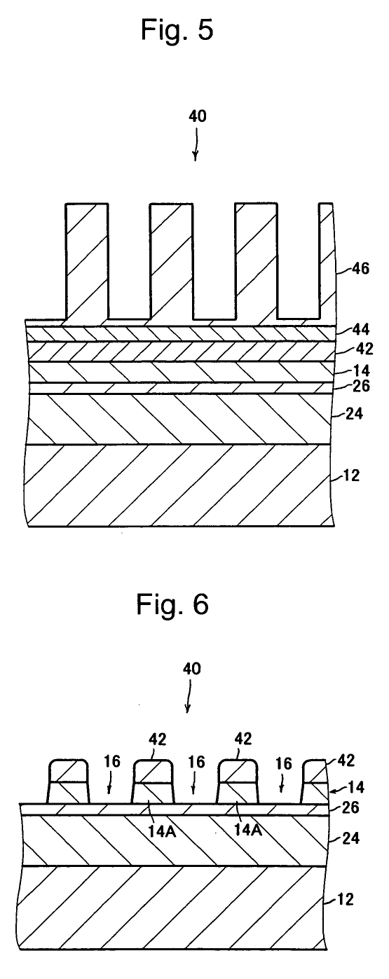

Next, as shown in FIG. 5, a resin material is applied to the second mask layer 44 of the workpiece 40 using a spin coating method. Then, a concavo-convex pattern corresponding to the concavo-convex pattern of the recording layer 14 is transferred to the resin material by an imprint method using a stamper (not shown), whereby a resin layer 46 having the concavo-convex pattern is formed (S104). Optical imprinting using UV light or the like, thermal imprinting, or the like may be used as the imprint method. When optical imprinting is used, a UV curable resin or the like may be used as the material for the resin layer 46. When thermal imprinting is used, a thermoplastic resin or the like may be used as the material for the resin layer 46. The thickness of the resin layer 46 (corresponding to the thickness of convex portions) is, for example, 10 to 300 nm. A photosensitive resist or an electron beam resist may also be used as the resin material. In such a case, a resin layer 46 having a concavo-convex pattern corresponding to the concavo-convex pattern of the recording layer 14 may be formed by optical lithography or electron beam lithography. The resin layer 46 under the bottom portions of the concave portions is removed by ashing or the like.

Next, the second mask layer 44 under the bottom portions of the concave portions is removed by IBE (Ion Beam Etching) or RIE (Reactive Ion Etching) using an inert gas such as Ar gas, and the first mask layer 42 under the bottom portions of the concave portions is removed by IBE or RIE using O₂ gas. Subsequently, the recording layer 14 under the bottom portions of the concave portions is removed by IBE or RIE using an inert gas such as Ar gas (S106). In this step, the recording layer 14 is formed into the concavo-convex pattern, i.e., is divided into a large number of recording elements 14A, as shown in FIG. 6. At this point, the second mask layer 44 is completely removed. The first mask layer 42 remaining over the upper surfaces of the recording elements 14A is not removed and is used as the temporary coating material. In this manner, a workpiece 40 is obtained which includes: the substrate 12; the recording layer 14 formed in the predetermined concavo-convex pattern over the substrate 12, the concavo-convex pattern including the convex portions that serve as the recording elements 14A; and the first mask layer 42 (temporary coating material) formed over the recording elements 14A and containing carbon as a main component.

In the description of the present application, the term “IBE” is used as a generic term for a processing method, such as ion milling, in which a workpiece is irradiated with an ionized gas to remove a target object thereof. In the description of the present application, even when a gas, such as an inert gas, that is not chemically reactive with a target object is used, the term “RIE” is used when an RIE apparatus is used for etching.

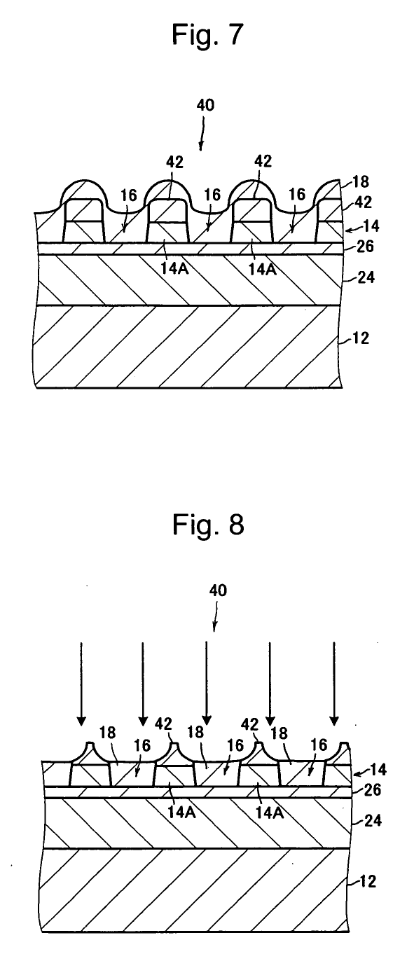

Next, as shown in FIG. 7, using a sputtering method or the like, the filling material 18 is deposited over the workpiece 40 including the recording layer 14 formed in the concavo-convex pattern, whereby the concave portions 16 between the recording elements 14A are filled with the filling material 18 (S108). The filling material 18 is deposited so as to cover the recording layer 14, i.e., is deposited also on the first mask layer 42 (temporary coating material) over the recording elements 14A following the concavo-convex pattern of the recording layer 14. In the description of the present application, the phrase “the filling material 18 deposited following the concavo-convex pattern of the recording layer 14” is not limited to the case where the filling material 18 is deposited in a concavo-convex pattern having the same contour as the contour of the concavo-convex pattern of the recording layer 14. The above phrase is also used to include the case where the filling material 18 is deposited in a concavo-convex pattern having a contour in which the widths of the convex or concave portions and/or the concavo-convex height are reduced or enlarged as compared to those of the contour of the concavo-convex pattern of the recording layer 14.

Next, as shown in FIG. 8, at least part of excess portions of the filling material 18 are removed by IBE or RIE using an inert gas such as Ar gas (S110). More specifically, at least part of the excess filling material 18 formed on the upper side (the side opposite to the substrate 12) of a level of the lower surfaces of the first mask layer (temporary coating material) 42 formed over the recording elements 14A is removed such that at least part of the side faces of the first mask layer 42 formed over the recording elements 14A are exposed. With a dry etching method such as IBE or RIE, convex portions tend to be selectively removed at a faster rate than concave portions. In particular, IBE and RIE have a strong tendency to remove convex portions at a faster rate than concave portions. Therefore, the filling material 18 that covers the first mask layer (temporary coating material) 42 can be efficiently removed.

In this step (S110), the etching is stopped such that the first mask layer (temporary coating material) 42 remains present over the recording elements 14A. In this manner, due to the presence of the first mask layer (temporary coating material) 42, the recording elements 14A are protected from being etched. After completion of this step, the filling material 18 may remain present on part of the first mask layer (temporary coating material) 42 over the recording elements 14A.

In this step (S110), it is preferable that the etching of the filling material 18 be stopped such that the level of the upper surfaces of the filling material 18 on the concave portions 16 is higher than the lower surfaces of the first mask layer (temporary coating material) 42 over the recording elements 14A, as shown in FIG. 8.

Moreover, in this step (S110), the irradiation angle of the processing gas is set to, for example, 90° relative to the surface of the workpiece 40. In the description of the present application, “the irradiation angle of the processing gas” is used to refer to the angle between the main traveling direction of the processing gas and the surface of the workpiece. For example, when the main traveling direction of the processing gas is parallel to the surface of the workpiece, the irradiation angle is 0°. When the main traveling direction of the processing gas is perpendicular to the surface of the workpiece, the irradiation angle is 90°. The arrows in FIG. 8 schematically indicate the traveling direction of the processing gas. When the irradiation angle of the processing gas is set to a large value as in the figure, a high etching rate is obtained, and this contributes to the improvement of the production efficiency. The processing gas travels less linearly in RIE than in IBE. Therefore, with RIE, even when the irradiation angle of the processing gas is set to 90° relative to the surface of the workpiece 40, part of the particles impinge on the workpiece 40 in directions inclined relative to the surface of the workpiece 40. Therefore, the convex portions are easily etched at a faster rate than the concave portions, so that the first mask layer (temporary coating material) 42 over the recording elements 14A is easily exposed from the filling material 18. The irradiation angle of the processing gas may be set to an angle smaller than 90°. In such a case, the tendency to remove the convex portions at a faster rate than the concave portions is increased. Therefore, the etching rate for the filling material deposited on the side surfaces of the first mask layer (temporary coating material) 42 increases accordingly, so that the side surfaces of the first mask layer (temporary coating material) 42 are easily exposed.

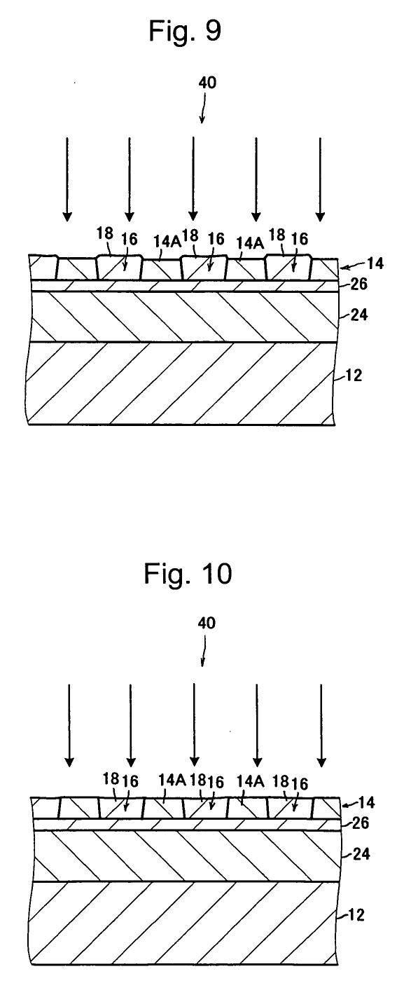

Next, the first mask layer (temporary coating material) 42 is removed using a dry etching method as shown in FIG. 9 (S112). In the dry etching method used, a reactive gas having the property of chemically reacting with and removing both the filling material 18 and the first mask layer (temporary coating material) 42 is used as a processing gas. In addition, the etching rate for the first mask layer (temporary coating material) 42 is higher than the etching rate for the filling material 18, and the etching rate for the filling material 18 is higher than the etching rate for the recording elements 14A (the lower layer that is in contact with the lower surfaces of the temporary coating material over the recording elements 14A). Specifically, the surface of the workpiece 40 is etched by IBE or RIE using a reactive gas containing nitrogen or fluorine. N₂ gas, NH₃ gas, or the like may be used as the nitrogen-containing reactive gas. CF₄ gas, C₂F₆ gas, C₄F₈ gas, SF₆ gas, CHF₃ gas, or the like may be used as the fluorine-containing reactive gas. Preferably, the processing gas is in the form of plasma.

Since the first mask layer (temporary coating material) 42 is made of a resin or a material containing carbon as a main component, this layer chemically reacts with the nitrogen-containing reactive gas, such as N₂ or NH₃ gas, or the fluorine-containing reactive gas, such as CF₄, C₂F₆, C₄F₈, SF₆, or CHF₃ gas, so that the layer becomes brittle and is rapidly removed. Since the filling material 18 is in contact with the upper surface of the first mask layer (temporary coating material) 42, the components of the filling material 18 may migrate into the upper surface portion of the first mask layer (temporary coating material) 42. Even in such a case, since the reactive gas used as the processing gas has the property of reacting with and removing not only the first mask layer (temporary coating material) 42 but also the filling material 18, the first mask layer (temporary coating material) 42 can be reliably removed. If the filling material 18 remains present on the first mask layer (temporary coating material) 42 over the recording elements 14A after completion of the filling material etching step (S110), the filling material 18 on the first mask layer (temporary coating material) 42 is removed together with the first mask layer (temporary coating material) 42.

The filling material 18 filled in the concave portions 16 also chemically reacts with the nitrogen-containing reactive gas and the fluorine-containing reactive gas. However, since the etching rate for the filling material 18 is lower than the etching rate for the first mask layer (temporary coating material) 42, the removed amount of the filling material 18 is less than the removed amount of the first mask layer (temporary coating material) 42.

When the filling material 18 is, for example, Ge, the etching rate for the filling material 18 is higher than the etching rate for the recording layer 14 in the next step (S114). In such a case, the etching in this step (S112) is stopped such that the level of the upper surfaces of the filling material 18 in the concave portions 16 is higher than the level of the upper surfaces of the recording elements 14A as shown in FIG. 9.

When the filling material 18 is, for example, W, the etching rate for the filling material 18 is substantially the same as the etching rate for the recording layer 14 in the next step (S114). In such a case, the etching in this step (S112) is stopped such that the level of the upper surfaces of the filling material 18 in the concave portions 16 is substantially the same as the level of the upper surfaces of the recording elements 14A as shown in FIG. 10.

Preferred combinations of the material for the first mask layer (temporary coating material) 42, the filling material 18, and the processing gas used in the temporary coating material removing step (S112) are shown in Table 1.

TABLE 1

| | First mask layer | | |
|---|---|---|---|
| | (temporary coating | | |
| | material) | Filling material | Processing gas |
| First | Material containing | Ge, Ge nitride, Ge oxide, mixture | Nitrogen-containing |
| combination | carbon as main | containing Ge (such as GeSb, GeAl, | gas such as N₂ gas |
| | component (such as | GeNb, GeZr, GeTe, or GeSi), Ge | or NH₃ gas |
| | DLC or C), resin | alloy, compound of Ge, Sb, Sb | |
| | | nitride, Sb oxide, mixture | |
| | | containing Sb (such as SbGe, SbGa, | |
| | | SbSn, SbIn, or SbTe), Sb alloy, or | |
| | | compound of Sb | |
| Second | Material containing | Ge, Ge nitride, Ge oxide, mixture | Fluorine-containing |
| combination | carbon as main | containing Ge (such as GeSb, GeAl, | gas such as CF₄, |
| | component (such as | GeNb, GeZr, GeTe, or GeSi), Ge | C₂F₆, C₄F₈, SF₆, |
| | DLC or C), resin | alloy, compound of Ge, Si, Si | or CHF₃ |
| | | nitride, Si oxide, mixture | |
| | | containing Si (such as SiNb, SiZr, | |
| | | SiCr, SiNi, or SiMn), Si alloy, | |
| | | compound of Si, Ta, Ta nitride, Ta | |
| | | oxide, Ta alloy (such as TaSi, TaNb, | |
| | | TaZr, TaCr, TaNi, or TaMn), Ti, Ti | |
| | | nitride, Ti oxide, Ti alloy (such | |
| | | as TiSi, TiNb, TiZr, TiCr, TiNi, or | |
| | | TiMn), W, W nitride, W oxide, or W | |
| | | alloy (such as WSi, WNb, WZr, WCr, | |
| | | WNi, or WMn) | |

Next, the upper surface portion of the workpiece 40 is removed by IBE or RIE using an inert gas such as Ar (S114). The upper surface portion of the workpiece 40 is, for example, a several nm thick portion including the upper surface of the workpiece 40 and the vicinity of the upper surface. With the IBE or RIE, the upper surface portions of the recording elements 14A and the upper surface portions of the filling material 18 filled in the concave portions 16 are removed. In the temporary coating material removing step (S112), the vicinity of the upper surfaces of the recording elements 14A can be denatured by the reactive gas. However, even when such denaturation occurs, the deterioration of the magnetic properties can be prevented by removing portions in the vicinity of the upper surfaces of the recording elements 14A.

When the filling material 18 is, for example, Ge, the etching rate for the filling material 18 is higher than the etching rate for the recording layer 14 during the IBE or RIE using an inert gas. In this case, when steps are formed between the upper surfaces of the filling material 18 and the upper surfaces of the recording elements 14A on completion of the temporary coating material removing step (S112), the step height is reduced, and the surface of the workpiece 40 is flattened with high precision.

When the filling material 18 is, for example, W, the etching rate for the filling material 18 is substantially the same as the etching rate for the recording layer 14 during the IBE or RIE using an inert gas. In this case, when the level of the upper surfaces of the filling material 18 is substantially the same as the level of the upper surfaces of the recording elements 14A on completion of the temporary coating material removing step (S112), the upper surface portions of the filling material 18 and the upper surface portions of the recording elements 14A are removed with the upper surfaces thereof held substantially flat against each other. Alternatively, on completion of the temporary coating material removing step (S112), small steps may be present between the upper surfaces of the recording elements 14A and the upper surfaces of the filling material 18 filled in the concave portions 16. In such a case, the degree of flatness can be further improved by etching and removing the upper surface portions of the recording elements 14A and the upper surface portions of the filling material 18 at different etching rates so as to reduce the step height. Although the inert gas does not cause a chemical reaction, the difference in the etching rate can be controlled by adjusting the irradiation angle.

Next, the protective layer 28 is deposited over the recording elements 14A and the filling material 18 by a CVD method (S116). Subsequently, the lubricant layer 30 is deposited on the protective layer 28 by a dipping method (S118). In this manner, the magnetic recording medium 10 shown in FIGS. 1 and 2 is completed.

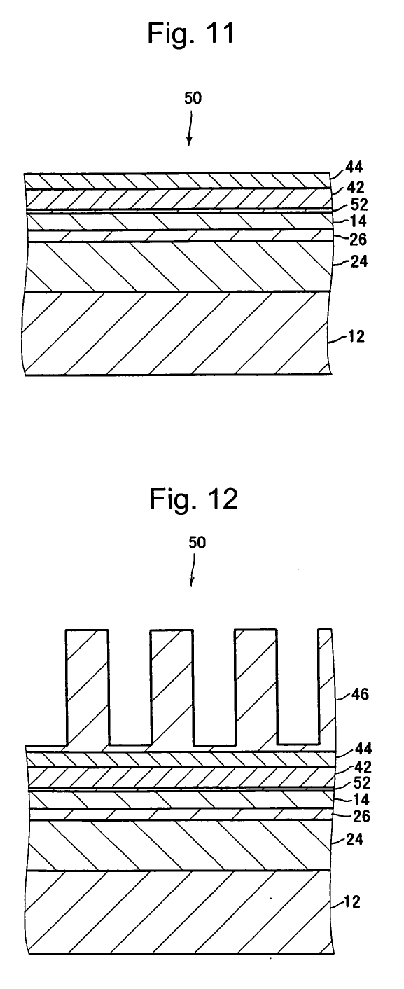

A description will now be given of a second exemplary embodiment of the present invention. In the first exemplary embodiment, the first mask layer (temporary coating material) 42 is formed in contact with the upper surface of the recording layer 14. However, in the second exemplary embodiment, a barrier film 52 is formed between the recording layer 14 and the first mask layer (temporary coating material) 42 as shown in FIG. 11 and other drawings. Since the configuration of other components is the same as that of the first exemplary embodiment, the same numerals as those used in FIGS. 1 to 10 are used for the same components, and the description thereof will be omitted.

First, a starting body of a workpiece 50 is prepared (S102). As shown in FIG. 11, the starting body of the workpiece 50 includes a barrier film 52 (being a continuous film before being processed into a concavo-convex pattern) deposited between the recording layer 14 (being a continuous film before being processed into a concavo-convex pattern) and the first mask layer 42.

The barrier film 52 has a thickness of 1 to 5 nm. SiO₂, MgO, ITO (Tin-Doped Indium Oxide), TaSi, Ti, TiN, TiO₂, SiC, or the like may be used as the material for the barrier film 52. In addition, Si, Ge, Mn, Ta, Nb, Mo, Zr, W, Al, Ni, Cu, Cr, Co, or the like, an alloy thereof, a compound thereof may be used as the material for the barrier film 52. As in other layers, the barrier film 52 can be deposited by a sputtering method or the like.

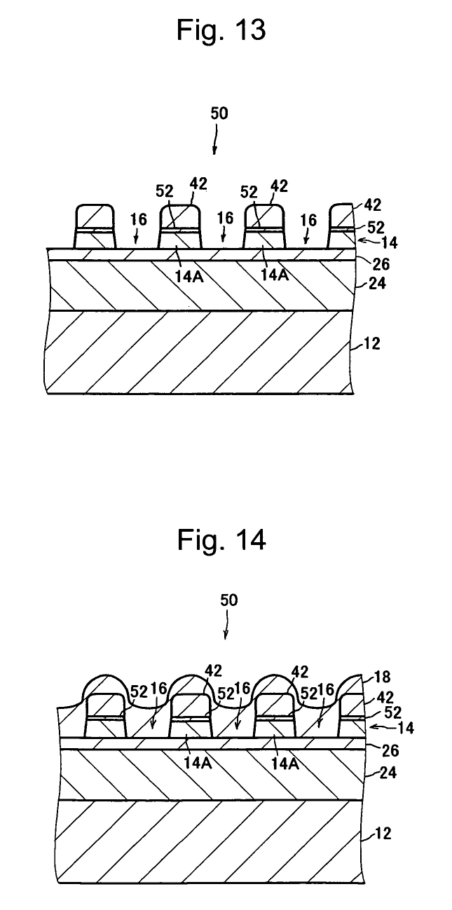

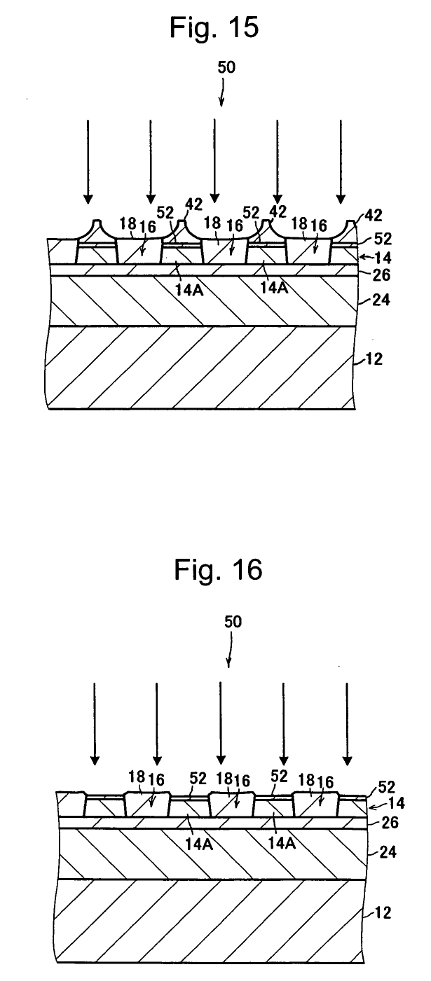

As in the first exemplary embodiment, the workpiece 50 is subjected to the resin layer forming step (S104), the recording layer processing step (S106), the filling material depositing step (S108), the filling material etching step (S110), and the temporary coating material removing step (S112) as shown in FIGS. 12 to 17.

In the recording layer processing step (S106), the barrier film 52 under the bottoms of the concave portions is removed together with the recording layer 14 under the bottoms of the concave portions.

In the temporary coating material removing step (S112), the first mask layer (temporary coating material) 42 is removed using a dry etching method. More specifically, In the dry etching method used, a reactive gas having the property of chemically reacting with and removing both the filling material 18 and the first mask layer (temporary coating material) 42 is used as a processing gas. In addition, the etching rate for the first mask layer (temporary coating material) 42 is higher than the etching rate for the filling material 18, and the etching rate for the filling material 18 is higher than the etching rate for the barrier film 52 (the lower layer that is in contact with the lower surfaces of the temporary coating material over the recording elements 14A). Since the barrier film 52 prevents the upper surfaces of the recording elements 14A from being etched, the vicinity of the upper surfaces of the recording elements 14A is not denatured by the reactive gas used in the temporary coating material removing step (S112).

When the etching rate for the filling material 18 is higher than the etching rate for the barrier film 52 in the upper surface portion removing step (S114), the etching in the temporary coating material removing step (S112) is stopped such that the level of the upper surfaces of the filling material 18 in the concave portions 16 is higher than the level of the upper surfaces of the barrier film 52 as shown in FIG. 16.

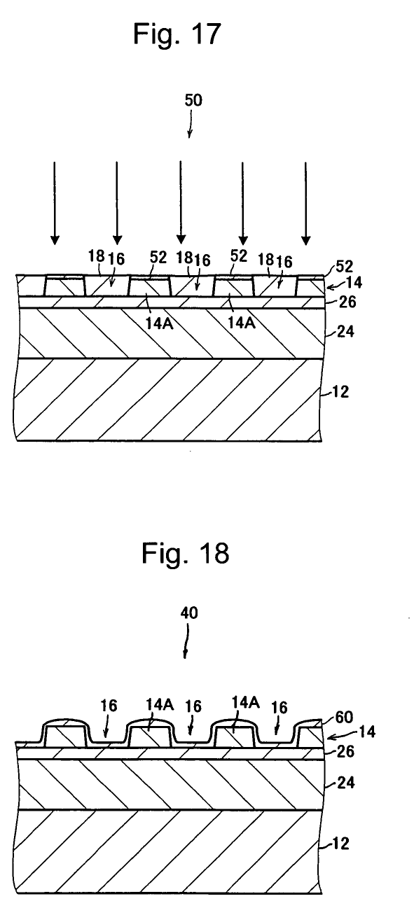

When the etching rate for the filling material 18 is substantially the same as the etching rate for the barrier film 52 in the upper surface portion removing step (S114), the etching in the temporary coating material removing step (S112) is stopped such that the level of the upper surfaces of the filling material 18 in the concave portions 16 is substantially the same as the level of the upper surfaces of the recording elements 14A as shown in FIG. 17.

Next, the upper surface portion of the workpiece 50 is removed by IBE or RIE using an inert gas such as Ar (S114). With the IBE or RIE, the barrier film 52 over the recording elements 14A and the upper surface portions of the filling material 18 filled in the concave portions 16 are removed. Note that the barrier film 52 may be removed in part or entirely.

In the IBE or RIE using an inert gas, the etching rate for the filling material 18 can be higher than the etching rate for the barrier film 52. In such a case, when steps are formed between the upper surfaces of the filling material 18 and the upper surfaces of the barrier film 52 on completion of the temporary coating material removing step (S112), the step height is reduced, and the surface of the workpiece 40 is flattened with high precision.

Alternatively, in the IBE or RIE using an inert gas, the etching rate for the filling material 18 can be substantially the same as the etching rate for the barrier film 52. In such a case, when the level of the upper surfaces of the filling material 18 is substantially the same as the level of the upper surfaces of the barrier film 52 on completion of the temporary coating material removing step (S112), the barrier film 52 and the upper surface portion of the filling material 18 are removed while the upper surfaces of both are substantially flush with each other. On completion of the temporary coating material removing step (S112), small steps may be present between the upper surfaces of the barrier film 52 over the recording elements 14A and the upper surfaces of the filling material 18 filled in the concave portions 16. In such a case, the degree of flatness can be improved by removing the barrier film 52 and the upper surface portion of the filling material 18 at different etching rates so as to reduce the step height. Although the inert gas does not cause a chemical reaction, the difference in the etching rate can be controlled by adjusting the irradiation angle.

By performing the protective layer depositing step (S116) and the lubricant layer depositing step (S118), the magnetic recording medium 10 shown in FIGS. 1 and 2 is obtained.

A description will now be given of a third exemplary embodiment of the present invention. In the first and second exemplary embodiments, the first mask layer 42 remains present over the recording elements 14A on completion of the recording layer processing step (S106), and the first mask layer 42 is used as the temporary coating material. In the third exemplary embodiment, a continuous recording layer 14 is processed into a concavo-convex pattern, and, after the first mask layer 42 is removed, a temporary coating material 60 is deposited over the recording layer 14 processed into the concavo-convex pattern, as shown in FIG. 18. The temporary coating material 60 is deposited also on the bottom and side surfaces of the concave portions 16, and the material deposited on the bottom and side surfaces remains in the final product. Since the configuration of other components is the same as that in the first and second exemplary embodiments, the same numerals as those used in FIGS. 1 to 17 are used for the same components, and the description thereof will be omitted. For convenience, in the manufacturing step shown in FIG. 18, the barrier film 52 is not formed between the recording layer 14 and the first mask layer 42 (temporary coating material) as in the first exemplary embodiment. However, when the barrier film 52 is formed between the recording layer 14 and the first mask layer 42 (temporary coating material) as in the second exemplary embodiment, the temporary coating material 60 is deposited over a workpiece 50 including the barrier film 52 formed over the recording elements 14A (this configuration is not shown in the drawings).

Also in the case that the temporary coating material 60 is deposited separately from the first mask layer 42 as described above, a magnetic recording medium having a structure similar to the structures of the magnetic recording media 10 in the first and second exemplary embodiments can be efficiently manufactured (except that the temporary coating material 60 is deposited on the bottom and side surfaces of the concave portions 16). Further, in this case, the material for the first mask layer 42 is not particularly restricted by the function as the temporary coating material, and any material suitable for processing the recording layer can be selected.

In the second exemplary embodiment, the barrier film 52 is deposited in the starting body preparing step (S102) for the workpiece 50. However, the barrier film may be deposited as follows. First, a starting body of a workpiece 40 having no barrier film is prepared as in the first exemplary embodiment, and the recording layer processing step (S106) is performed. After the first mask layer 42 is removed, the barrier film is deposited over the processed workpiece 40. Subsequently, the temporary coating material 60 may be deposited over the barrier film. In this manner, due to the presence of the barrier film, the upper surface portions of the recording elements 14A can be protected from the reactive gas in the temporary coating material removing step (S112) as in the second exemplary embodiment. In this case, not only the temporary coating material 60 but also the barrier film is deposited on the bottom and side surfaces of the concave portions 16 and remains in the final product.

In the example shown in FIG. 18, the temporary coating material 60 is deposited after the first mask layer 42 is removed. However, the first mask layer 42 may remain over the recording elements 14A. In this case, the first mask layer 42 remaining over the recording elements 14A may be used as part of the temporary coating layer, and the temporary coating material 60 may be deposited on the remaining first mask layer 42. In this case, the material for the temporary coating material 60 may be the same as or different from the material for the first mask layer 42, so long as the etching rate for that material is higher than the etching rate for the filling material 18 in the temporary coating material removing step (S112).

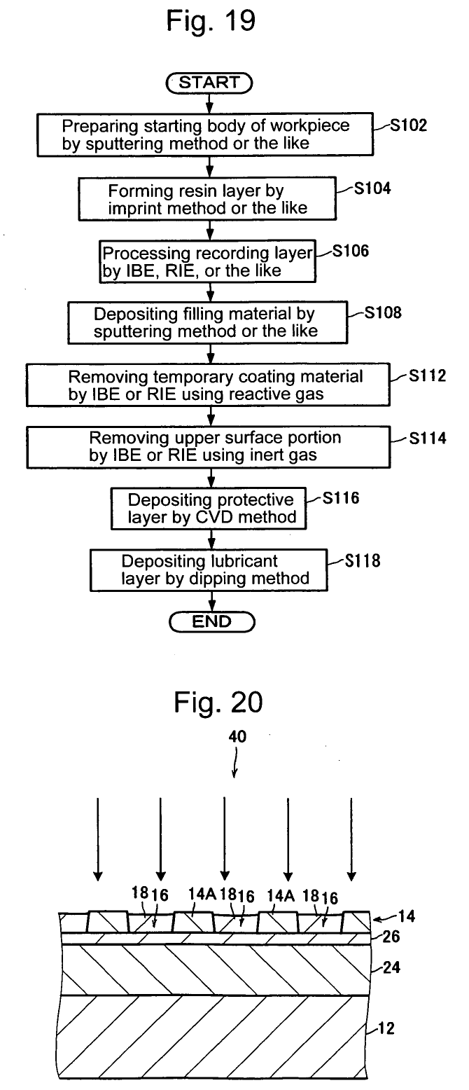

A description will now be given of a fourth exemplary embodiment of the present invention. In the first to third exemplary embodiments, the excess portions of the filling material 18 and the first mask layer (temporary coating material) 42 are removed in two steps including the filling material etching step (S110) using an inert gas and the temporary coating material removing step (S112) using a reactive gas. In the fourth exemplary embodiment, the filling material etching step is omitted as shown in FIG. 19. More specifically, in the fourth exemplary embodiment, the excess portions of the filling material 18 and the first mask layer (temporary coating material) 42 are removed only in the temporary coating material removing step (S112). In other words, the temporary coating material removing step (S112) serves also as the filling material etching step. Since the other steps are the same as those in the first to third exemplary embodiments, the same numerals as those used in FIGS. 1 to 18 are used for the same steps, and the description thereof will be omitted.

In the temporary coating material removing step (S112), a reactive gas that has the property of chemically reacting with and removing not only the first mask layer (temporary coating material) 42 the temporary coating material 60 but also the filling material 18 is used as the processing gas. Therefore, the excess portions of the filling material 18 can be removed. Since the temporary coating material removing step (S112) serves also as the filling material etching step as described above, the number of steps can be reduced, and the production efficiency can thereby be improved.

A description will now be given of a fifth exemplary embodiment of the present invention. In the first to fourth exemplary embodiments, the upper surface portion of the workpiece 40 (50) is removed in the upper surface portion removing step (S114) such that the level of the recording elements 14A (or the barrier film 52) agrees with the level of the upper surfaces of the filling material 18. In the fifth exemplary embodiment, the upper surface portion of the workpiece 40 is removed in the upper surface portion removing step (S114) such that the level of the upper surfaces of the filling material 18 is lower than the level of the upper surfaces of the recording elements 14A as shown in FIG. 20. Since the other steps are the same as those in the first to fourth exemplary embodiments, the same numerals as those used in FIGS. 1 to 19 are used for the same steps, and the description thereof will be omitted.

Even when the level of the upper surfaces of the filling material 18 is lower than the level of the upper surfaces of the recording elements 14A (or the barrier film 52) as described above, the flying characteristics of a magnetic head can be favorable, so long as the step height is small (several nm).

In the first to fifth exemplary embodiments, the upper surface portion removing step (S114) is performed between the temporary coating material removing step (S112) and the protective layer depositing step (S116). However, when the upper surface portions of the recording elements 14A are not denatured, the upper surface portion removing step (S114) may be omitted. Also when the denaturation occurs but does not cause any practical problem, the upper surface portion removing step (S114) may be omitted. Moreover, also when the barrier film 52 remains present over the recording elements 14A but does not cause any practical problem, the upper surface portion removing step (S114) may be omitted. When the upper surface portion removing step (S114) is omitted, the etching of the filling material 18 in the filling material etching step (S110) is stopped such that the level of the upper surfaces of the filling material 18 on the concave portions 16 is higher than the lower surfaces of the first mask layer (temporary coating material) 42 (or the temporary coating material 60) over the recording elements 14A by a height corresponding to the amount of the filling material 18 to be etched in the temporary coating material removing step (S112). In this manner, the flattening can be achieved with high precision.

In the first to fifth exemplary embodiments, the first mask layer 42, the second mask layer 44, and the resin layer 46 are formed on the recording layer 14 formed of a continuous film, and the recording layer 14 is divided into a concavo-convex pattern by three-step dry etching. However, no particular limitation is imposed on the mask layers, the material for the resin layer, the number of stacked layers, the thicknesses of these layers, the type of dry etching, and the like, so long as the recording layer 14 can be processed with high precision.

In the first to fifth exemplary embodiments, the soft magnetic layer 24 and the seed layer 26 are formed below the recording layer 14. However, the configuration of the layers below the recording layer 14 may be appropriately changed according to the type of the magnetic recording medium. For example, an underlayer and/or an antiferromagnetic layer may be formed between the soft magnetic layer 24 and the substrate 12. One or both of the soft magnetic layer 24 and the seed layer 26 may be omitted. Moreover, the recording layer may be formed directly on the substrate.

In the first to fifth exemplary embodiments, the recording layer is formed on one side of the substrate. However, it is appreciated that various exemplary embodiments of the present invention are applicable also when a magnetic recording medium having recording layers on both sides of the substrate is manufactured.

In the first to fifth exemplary embodiments, the magnetic recording medium 10 is a discrete track medium of the perpendicular recording type in which the recording layer 14 is divided into tracks with microscopic radial intervals. However, various exemplary embodiments of the present invention are, of course, applicable also to: a patterned medium in which the recording layer is divided with microscopic intervals in both the radial and circumferential directions of tracks; a magnetic disk including a spiral-shaped recording layer; a magnetic disk including a recording layer that is formed separately on the upper surfaces of the convex portions of a concavo-convex pattern of a layer below the recording layer and on the concave portions of the concavo-convex pattern, with the portions formed on the upper surfaces of the convex portions serving as the recording elements; a magnetic disk including a recording layer having concave portions that are formed to a certain depth in the thickness direction such that the recording layer is continuous in the bottom portion of the concave portions; and a magnetic disk including a recording layer formed of a continuous film formed in a concavo-convex pattern following the concavo-convex pattern of a layer below the recording layer. Of course, various exemplary embodiments of the present invention are applicable also to the manufacturing of magnetic disks of a longitudinal recording type. Moreover, various exemplary embodiments of the present invention are applicable also to the manufacturing of a magneto-optical disk such as MO disk, a magnetic disk of a heat assisted type in which magnetism and heat are used, and a magnetic recording medium, such as a magnetic tape, having a shape other than a disk shape and including a recording layer formed in a concavo-convex pattern.

### WORKING EXAMPLE

A magnetic recording medium 10 was produced in the manner described in the first exemplary embodiment.

Specifically, in the starting body preparing step (S102) for the workpiece 40, the recording layer 14 was deposited to be of a thickness of 20 nm.

In the resin layer forming step (S104), a UV curable resin was used as the resin material, and the resin layer 46 was formed into a concavo-convex pattern corresponding to the concavo-convex pattern of the recording layer 14 by an optical imprinting method.

In the recording layer processing step (S106), the recording layer 14 was processed such that, in the data areas, the radial width of the upper surfaces of the recording elements 14A is 50 nm and the radial width of the concave portions 16 at the level of the upper surfaces of the recording elements 14A is 50 nm. The first mask layer (temporary coating material) 42 having a thickness of 20 nm remained on the recording elements 14A. C (carbon) was used as the material for the first mask layer (temporary coating material) 42.

In the filling material depositing step (S108), a filling material 18 (Ge) was deposited to a thickness of 50 nm by a sputtering method. The deposition conditions were as follows.

Source power (the power applied to the target): 500 W

Bias power (the power applied to the workpiece 40): 500 W

Inner pressure of the chamber: 0.3 Pa

Distance between the target and the workpiece: 300 mm

In the filling material etching step (S110), the filling material 18 on the concave portions 16 was removed by IBE using Ar gas to a level 10 nm above the lower surfaces of the first mask layer (temporary coating material) 42 over the recording elements 14A (the upper surfaces of the recording elements 14A). The filling material 18 over the recording elements 14A was completely removed. The etching conditions were as follows.

Flow rate of Ar gas: 11 sccm

Inner pressure of the chamber: 0.03 Pa

Irradiation angle of the processing gas: 90°

Beam voltage: 1,000 V

Beam current: 500 mA

Suppressor voltage: −400 V

In the temporary coating material removing step (S112), the first mask layer 42 (temporary coating material) over the recording elements 14A was completely removed by RIE using N₂ gas. At this time, the filling material 18 on the concave portions 16 was removed to the level of the lower surfaces of the first mask layer (temporary coating material) 42 over the recording elements 14A (the upper surfaces of the recording elements 14A). The etching conditions were as follows.

Flow rate of N₂ gas: 50 sccm

Inner pressure of the chamber: 1.0 Pa

Microwave power: 1,000 W

Bias voltage applied to the workpiece 40: 150 V

Processing time: 40 sec

Subsequently, the protective layer depositing step (S116) and the lubricant layer depositing step (S118) were performed, whereby the magnetic recording medium 10 was produced. Note that the upper surface portion removing step (S114) was not performed.

The flatness of the surface of the thus-obtained magnetic recording medium 10 was measured using an AFM (atomic force microscope). The upper surfaces of the filling material 18 filled in the concave portions 16 were at substantially the same level as the upper surfaces of the recording elements 14A. The first mask layer (temporary coating material) 42 did not remain over the recording elements 14A. The surface roughness Ra of the magnetic recording medium 10 was 0.7 nm. Moreover, the static magnetic properties of the magnetic recording medium 10 were measured using the magnetic Kerr effect. The processed recording layer 14 did not deteriorate in its static magnetic properties as compared to the recording layer formed of a yet-to-be-processed continuous film.

The magnetic recording medium 10 was installed in a magnetic recording-reproducing apparatus, and the flying characteristics of the magnetic head were tested. The flying characteristics were found to be stable.

### Comparative Example 1

In contrast to the above Working Example, a filling material 18 composed of Nb was deposited in the filling material depositing step (S108) to have a thickness of 50 nm using a sputtering method. The deposition conditions were the same as those in Working Example. In the filling material etching step (S110), the filling material 18 on the concave portions 16 was removed to the level of the upper surfaces of the recording elements 14A. In the temporary coating material removing step (S112), O₂ gas was used as the processing gas. Note that Nb is hardly etched by a chemical reaction during etching using O₂ gas but is slightly etched due to physical action.

A magnetic recording medium 10 was produced under the same conditions as those in Working Example except for the above.

The flatness of the surface of the thus-obtained magnetic recording medium 10 was measured using an AFM. The upper surfaces of the filling material 18 filled in the concave portions 16 were at substantially the same level as the upper surfaces of the recording elements 14A. However, the first mask layer 42 (temporary coating material) remained partially on the upper surfaces of the recording elements 14A, and the maximum protruding height of the first mask layer 42 (temporary coating material) (in the thickness direction of the magnetic recording medium 10) was about 10 nm.

The static magnetic properties of the magnetic recording medium 10 were measured using the magnetic Kerr effect. As in Working Example, the processed recording layer 14 did not deteriorate in its static magnetic properties as compared to the recording layer formed of a yet-to-be-processed continuous film.

The magnetic recording medium 10 was installed in a magnetic recording-reproducing apparatus, and the flying characteristics of the magnetic head were tested. The magnetic head crashed on the surface of the magnetic recording medium 10 and was damaged.

Moreover, different magnetic recording media 10 were produced under different conditions while the etching time in the temporary coating material removing step (S112) was changed to 80 sec, 120 sec, and 160 sec which were longer than 40 sec. The other conditions were the same as those in Comparative Example 1. The maximum protruding height of the first mask layer 42 (temporary coating material) (in the thickness direction of each magnetic recording medium 10) was about 10 nm, which is the same as the maximum protruding height in the above one. This shows that even when a longer etching time is used in the temporary coating material removing step (S112), it is difficult to remove the first mask layer 42 (temporary coating material).

A sample having a pure carbon-made first mask layer 42 (temporary coating material) deposited on a flat substrate was prepared, and the pure carbon-made first mask layer 42 was etched under the same conditions as those in the temporary coating material removing step (S112) in Comparative Example 1. The etching rate for the first mask layer 42 was 2.5 nm/sec.

Another sample was prepared by depositing a pure carbon-made first mask layer 42 (temporary coating material) on a flat substrate and depositing Nb to a thickness of 50 nm on the deposited first mask layer under the same conditions as those in Comparative Example 1. The deposited Nb was etched 50 nm by IBE using Ar under the same conditions as those in the filling material etching step (S110) in Comparative Example 1, and the carbon-made first mask layer 42 was etched by RIE using O₂ gas under the same conditions as those in the temporary coating material removing step (S112) in Comparative Example 1. The etching rate for the first mask layer 42 just after the etching was started was 1.5 nm/sec.

Namely, it was confirmed that the etching rate for the resultant carbon-made first mask layer 42 (temporary coating material) was significantly reduced as compared to the etching rate for the pure carbon-made first mask layer 42 (temporary coating material) due to the Nb filling material deposited on the first mask layer 42 (temporary coating material). This may be because, a component of the filling material 18 that had been in contact with the upper surface of the first mask layer 42 (temporary coating material) migrated into the upper surface portion of the first mask layer 42 (temporary coating material).

### Comparative Example 2

In contrast to Comparative Example 1, a filling material 18 composed of Ge, in place of Nb, was deposited to a thickness of 50 nm in the filling material depositing step (S108). Similar to Nb, Ge is hardly etched by a chemical reaction during etching using O₂ gas but is slightly etched due to physical action.

A magnetic recording medium 10 was produced under the same conditions as those in Comparative Example 1 except for the above, and the produced magnetic recording medium 10 was tested as in Comparative Example 1. The test results were the same as those in Comparative Example 1.

As has been described, in Working Example of the present invention, the first mask layer 42 (temporary coating material) was removed using, as a processing gas, a reactive gas having the property of chemically reacting with and removing both the filling material 18 and the first mask layer 42 (temporary coating material) In Comparative Examples 1 and 2, the first mask layer 42 (temporary coating material) was removed using a reactive gas that does not chemically react with the filling material 18. Therefore, according to Working Example of the present invention, a magnetic recording medium having a surface with improved flatness can be manufactured. Moreover, this magnetic recording medium has good magnetic properties and can provide good flying characteristics of a magnetic head.

What is claimed is:

1. A method for manufacturing a magnetic recording medium, comprising:
a workpiece producing step of producing a workpiece including a substrate, a recording layer formed over the substrate in a predetermined concavo-convex pattern that includes convex portions serving as recording elements, and a temporary coating material formed over at least the recording elements of the recording layer;
a filling material depositing step of depositing, over the workpiece, a filling material different from the temporary coating material to fill concave portions of the concavo-convex pattern;
a filling material etching step of removing at least part of an excess portion of the filling material by a dry etching method such that at least part of a side face of the temporary coating material formed over the recording elements is exposed, the excess portion of the filling material being a portion formed on an upper side of a level of a lower surface of the temporary coating material over the recording elements, the upper side being a side opposite to the substrate; and
a temporary coating material removing step of removing the temporary coating material by a dry etching method which uses, as a processing gas, a reactive gas having a property of chemically reacting with and removing both the filling material and the temporary coating material and in which an etching rate for the temporary coating material is higher than an etching rate for the filling material and the etching rate for the filling material is higher than an etching rate for a lower layer that is in contact with the lower surface of the temporary coating material over the recording elements.

2. The method for manufacturing a magnetic recording medium according to claim 1, wherein one of a first combination and a second combination is used, with the first combination in which the temporary coating material is one of a resin and a material containing carbon as a main component, the filling material is a material containing at least one of Ge and Sb, and the processing gas used in the temporary coating material removing step is a reactive gas containing nitrogen, and with the second combination in which the temporary coating material is one of a resin and a material containing carbon as a main component, the filling material is a material containing at least one of Ge, Si, Ta, Ti, and W, and the processing gas used in the temporary coating material removing step is a reactive gas containing fluorine.

3. The method for manufacturing a magnetic recording medium according to claim 1, wherein the temporary coating material removing step also serves as the filling material etching step.

4. The method for manufacturing a magnetic recording medium according to claim 2, wherein the temporary coating material removing step also serves as the filling material etching step.

5. The method for manufacturing a magnetic recording medium according to claim 1, wherein, in the filling material etching step, etching of the filling material is stopped such that a level of an upper surface of the filling material on the concave portions of the concavo-convex pattern is higher than the lower surface of the temporary coating material over the recording elements.

6. The method for manufacturing a magnetic recording medium according to claim 2, wherein, in the filling material etching step, etching of the filling material is stopped such that a level of an upper surface of the filling material on the concave portions of the concavo-convex pattern is higher than the lower surface of the temporary coating material over the recording elements.

7. The method for manufacturing a magnetic recording medium according to claim 1, further comprising, after the temporary coating material removing step, an upper surface portion removing step of removing an upper surface portion of the workpiece by a dry etching method using an inert gas as a processing gas.

8. The method for manufacturing a magnetic recording medium according to claim 2, further comprising, after the temporary coating material removing step, an upper surface portion removing step of removing an upper surface portion of the workpiece by a dry etching method using an inert gas as a processing gas.

9. The method for manufacturing a magnetic recording medium according to claim 3, further comprising, after the temporary coating material removing step, an upper surface portion removing step of removing an upper surface portion of the workpiece by a dry etching method using an inert gas as a processing gas.

10. The method for manufacturing a magnetic recording medium according to claim 5, further comprising, after the temporary coating material removing step, an upper surface portion removing step of removing an upper surface portion of the workpiece by a dry etching method using an inert gas as a processing gas.

11. The method for manufacturing a magnetic recording medium according to claim 7, wherein, in the upper surface portion removing step, the upper surface portion of the workpiece is removed such that the level of the upper surface of the filling material is equal to or lower than an upper surface of the recording elements.

12. The method for manufacturing a magnetic recording medium according to claim 1, wherein, in the workpiece producing step, the recording layer is formed into the concavo-convex pattern by forming a continuous recording layer over the substrate, covering, with a mask layer, portions of the continuous recording layer that correspond to the convex portions of the concavo-convex pattern, and removing exposed portions of the continuous recording layer that are not covered with the mask layer by an etching method, and wherein the mask layer remaining over the recording elements is used as at least part of the temporary coating material.

13. The method for manufacturing a magnetic recording medium according to claim 3, wherein, in the workpiece producing step, the recording layer is formed into the concavo-convex pattern by forming a continuous recording layer over the substrate, covering, with a mask layer, portions of the continuous recording layer that correspond to the convex portions of the concavo-convex pattern, and removing exposed portions of the continuous recording layer that are not covered with the mask layer by an etching method, and wherein the mask layer remaining over the recording elements is used as at least part of the temporary coating material.

14. The method for manufacturing a magnetic recording medium according to claim 5, wherein, in the workpiece producing step, the recording layer is formed into the concavo-convex pattern by forming a continuous recording layer over the substrate, covering, with a mask layer, portions of the continuous recording layer that correspond to the convex portions of the concavo-convex pattern, and removing exposed portions of the continuous recording layer that are not covered with the mask layer by an etching method, and wherein the mask layer remaining over the recording elements is used as at least part of the temporary coating material.

15. The method for manufacturing a magnetic recording medium according to claim 7, wherein, in the workpiece producing step, the recording layer is formed into the concavo-convex pattern by forming a continuous recording layer over the substrate, covering, with a mask layer, portions of the continuous recording layer that correspond to the convex portions of the concavo-convex pattern, and removing exposed portions of the continuous recording layer that are not covered with the mask layer by an etching method, and wherein the mask layer remaining over the recording elements is used as at least part of the temporary coating material.
